(19) United States
(12) Patent Application Publication
(10) Pub. No.: US 2025/0100314 A1
(43) Pub. Date: Mar. 27, 2025

(54) METHOD FOR PROVIDING A DIGITAL EMERGENCY CARD

(71) Applicant: ZF Friedrichshafen AG, Friedrichshafen (DE)

(72) Inventor: Stefan Traub, Friedrichshafen (DE)

(73) Assignee: ZF Friedrichshafen AG, Friedrichshafen (DE)

(21) Appl. No.: 18/897,528

(22) Filed: Sep. 26, 2024

(30) Foreign Application Priority Data
Sep. 27, 2023 (DE) 10 2023 209 425.8

(51) Int. Cl. B42D 25/23; B42D 25/22; B42D 25/28

(52) U.S. Cl. CPC B42D 25/23; B42D 25/22; B42D 25/28

(57) ABSTRACT

A method is disclosed for providing a digital emergency card, the method including a user creating (S1) the digital emergency card for a building (2) and storing (S2) the created emergency card in a storage medium (4) of the building (2). In addition, the method includes reading (S3) the stored emergency card from the storage medium (4) and transmitting (4) the emergency card, once read. Furthermore, a system is disclosed which consists of a storage medium (4), a terminal (6), and a transmission and receptions device (8), the system being designed to carry out steps of such a method.

### RELATED APPLICATIONS

This application claims the benefit of and right of priority under 35 U.S.C. § 119 to German Patent Application no. 10 2023 209 425.8, filed on 27 Sep. 2023, the contents of which are incorporated herein by reference in its entirety.

### TECHNICAL FIELD

The present invention relates to a method for providing a digital emergency card. In addition, the invention relates to a system for carrying out such a method.

### BACKGROUND

From the prior art emergency cards in the field of passenger cars are known. A passenger car can have an emergency card that is visible from the outside. The emergency card can display information that can be used by an emergency service from outside the passenger car. With that information, for example, the rescue of a person from the passenger car can be facilitated. For example, the emergency card can indicate where shears or spreaders should be used.

### SUMMARY

A first aspect of the present invention relates to a method for providing a digital emergency card. The digital emergency card can be an emergency card for private households. The digital emergency card can be an emergency card for commercial premises. The digital emergency card can contain information which emergency services such as a rescue team or firefighters can provide in an emergency. The digital emergency card can contain information which may be advantageous in an emergency. For example, the digital emergency card can contain information about the layout of the building to which the emergency card relates. With this, besides normal information such as an address and an approximate description of the hazards involved, the digital emergency card can provide further information about the building which may be helpful in an emergency.

The method comprises the creation by a user, of the digital emergency card for a building. The digital emergency card can be created by the user, in that the user can be assisted by way of instructions in an application, for example on a mobile terminal device such as a Smartphone when creating the digital emergency card. Exactly one digital emergency card can be created for a building. The user can be for example a resident or a worker in the building.

Furthermore, the digital emergency card created is stored in a storage medium in the building. The storage medium can for example be a central server in the building. Thus, exactly one digital emergency card for the building can be created and stored in the server of the building. Besides the creation of a digital emergency card for a building by a user, the same or even another user can also draw up an additional digital emergency card for another building. This additional digital emergency card created can be stored in a further storage medium of the other building. In that way each building can have exactly one storage medium with exactly one digital emergency card drawn up and stored for it.

Moreover, the stored digital emergency card is read from the storage medium. In terms of time the stored digital emergency card can be read minutes, hours, days, weeks, or years after it has been created and stored. For example, the user can create the digital emergency card on entry into the building and store it in the storage medium. It can then be read if and when an emergency occurs, for example years after the digital emergency card has been created.

Furthermore, after being read the digital emergency card can be transmitted. The digital emergency card can be transmitted to emergency services directly or indirectly via a server (not specified in more detail here) or a center of operations. For the transmission the digital emergency card can be encrypted. For the encryption of the digital emergency card a key can be used, which after the digital emergency card has been received and read, no longer remains valid. For example, after the digital emergency card has been read, encrypted, and then transmitted, the key for encrypting and deciphering the encrypted digital emergency card becomes invalid after the lapse of a certain amount of time after the encryption. The steps of creating the emergency card and then storing the emergency card created can be initiated by a user, for example, a resident of the building. The steps of reading the stored emergency card and transmitting the emergency card after it has been read can be carried out regardless of the time that has passed since the user initiated the process.

It can be ensured that a user of the building creates and stores an emergency card, and that in an emergency this emergency card is read and transmitted. For example, as a resident of the building the user can have a particularly good knowledge of information about the building such as a layout plan or specific hazards, such as gas stoves. A digital emergency card that he has created can therefore give a particularly accurate picture of the condition of the building, which in an emergency can be important for emergency services such as firefighters. Moreover, the safety of the firefighters themselves can be increased since information about the building can be available from the digital emergency card already before it is used, for example on approaching the building or when an alarm goes off. Firefighters can then, for example, focus on a layout or a hazard such as a gas stove in advance and plan the equipment to deploy and a team for the operation. Moreover, the chances for the rescue of people in the building can be increased, since more detailed information about the building is available and the operation can be designed accordingly. Furthermore, for example, a target for an operation can be defined since, for example, the information in the digital emergency card can include the set of people in the building. Moreover, data security can be increased since the storage medium in which the emergency card created is stored, is in the building. The user, for example, a resident in the building, can therefore have control over the digital emergency card stored therein. Thus, there is no need for an emergency card stored away from the building, for example in an external server, granted that the data in an emergency card stored away from the building is in many cases less secure. In addition, there may be cost advantages for a storage medium in the building compared with a storage medium outside the building.

In a further embodiment the method can be characterized in that after being read, the emergency card can be updated. Updating can be carried out by the user. Updating can be done by means of the application that assists the user to create the card. For example, only the user who has created the digital emergency card can update the emergency card when it has been read. Updating can for example take place whenever the condition of the building has changed. For example, the condition of the building has changed if the layout of the building changes, for example, by changing the walls. The condition can also change by virtue of a changed set of reported people or people detected therein for a certain time, or new sources of risk such as a new solar unit, purchased spray-cans or a gas stove. Thus, the updating of the read emergency card can include updating of information about a condition, for example information about a hazardous feature of the building. Moreover, the updated emergency card can be stored in the storage medium. When the updated emergency card is stored in the storage medium, for example, the previous emergency card can be overwritten, such as a previously updated emergency card or the emergency card originally created. When transmitting, the updated emergency card can be sent.

Thus, with the method, the emergency card can be updated if a hazard situation in the building has changed. The user bears the responsibility for the updating. By having the storage medium in the building, updating is technically simpler. Thus, emergency services with information from an updated emergency card can plan the operation. This increases safety for the emergency services during the operation and the probability of success in rescuing the people in the building.

According to a further embodiment, the method can be characterized in that a reminder is transmitted to the user to carry out an update. The reminder is sent when a defined time interval since the last update has lapsed. For example, the updating can take pace cyclically. For example, the sending of the reminder can be controlled by the application which can be used for creating the digital emergency card.

The transmission of such a reminder can ensure that the digital emergency card stored in the storage medium of the building corresponds to the actual condition of the building. This can avoid situations such as the user forgetting to update, so that a stored emergency card is read and sent which no longer corresponds to the current situation of the building.

In a further embodiment, the method can be characterized in that a validation of the emergency card, once read, takes place. Alternatively, or in addition, the digital emergency card created can be validated. Validation can be carried out by the user. Moreover, the validated emergency card can be stored in the storage medium. Validation can take place by a customary certification process. The validated emergency card can be stored immediately after it has been validated. Furthermore, for the transmission the validated emergency card can be sent, for example instead of an emergency card that has not been validated. Thus, for example, only a validated emergency card can be transmitted. For example, transmission can only take place when the emergency card has also been validated.

In this way it can be ensured that only validated emergency cards are sent. Validation can take place by a certification process wherein it can be ensured that the information on the emergency card created, stored and validated corresponds to the actual condition of the building, so that emergency services can rely on that information.

In a further embodiment, the method can be characterized in that in that validation can be carried out by an external user. The external user can be for example an emergency operative such as a firefighter or some other technician such as a chimneysweep. Validation by an external user can take place for example when the digital emergency card is created to begin with and has never been updated. Alternatively, or in addition, validation can be done by the external user after the updating. In that case it can take place after every updating, or alternatively only after certain updating steps, such as when particular conditions of the building have changed, for example its layout. After other updating steps, however, in an embodiment validation by the external user may not be necessary since the basic condition of the building has not changed, for example if the set of people in the building is different.

Thus, it can be ensured that validation is carried out by a professional user as the external user, for example an emergency operative. For example, for the initial validation of an initially created digital emergency card it may be advantageous and necessary for validation to be carried out by the external user so that the basic information stored in the digital emergency card is correct and helpful for use during an operation. However, there is no need for validation after any arbitrary updating of the emergency card, provided that for example the updating relates only to minor condition changes of the building.

According to a further embodiment, the method can be characterized in that the validated emergency card can indicate a confidence level. For example, by virtue of the validation, for example by an external user, the emergency card can acquire a particular confidence level. The confidence level can indicate to what extent and alternatively or in addition by whom and when the emergency card has been validated. For example, the confidence level is higher if an emergency operative or a specialist carries out the validation. When the user himself carried out the validation, the emergency card can have a lower confidence level. Moreover, the confidence level can decline over time, for example in a linear manner. The confidence level can decrease if the emergency card is not updated and alternatively or in addition not validated. Furthermore, the transmission of the emergency card after reading can depend on the confidence level. Thus, if the confidence level is low, for example below a particular threshold, no transmission of the read emergency card takes place. Alternatively, or in addition the transmission of the emergency card can take place with additional information about the confidence level. Moreover, the reminder to update can be sent to the user if the confidence level has fallen below a particular value. The particular value can be chosen such that above that particular value the confidence level is still high enough for the emergency services to be able to plan the operation on the basis of the information in the emergency card. For example, the particular value is higher than the particular threshold. Updating by the user can include the case when the condition of the building has changed. Furthermore, after the updating the confidence level can increase. In that case the confidence level can be increased to a value above the particular value. As an alternative to updating, validation by the user can take place whereby the confidence level can be increased so that it is above the particular value. For that purpose, a validation reminder is sent before transmission. The validation can include the case that the condition of the building has not changed.

In this way it can be ensured that the information stored on the digital card is current. Moreover, when that can no longer be the case, sending the reminder to the user to update or validate is triggered so that the user updates the information or at least validates it and thereby increases the confidence level. It can thus be ensured that the user actively guarantees that the information stored on the digital emergency card corresponds to the current condition of the building.

According to a further embodiment, the method can be characterized in that the transmission can take place subject to approval by the user. The transmission can take place provided that the user has granted his approval. The transmission cannot take place if the user has not granted approval. The transmission can take place just as soon as the user has granted his approval. The user can grant the approval when creating the emergency card or independently of that time and, for example, at a time later than its creation.

In that way it can be ensured that only an emergency card created and approved by the user is transmitted. This prevents information on the emergency card and thus information about the building from being sent without approval by the user. That can increase data security.

In a further embodiment, the method can be characterized in that a current query is addressed to the user. The current query to the user can be submitted for example by a central emergency service or an emergency team on the way to the building and in the case of an emergency. Transmission can then take place, for example, only when the user approves the transmission in reaction to a current query. For example, the user can actively approve the transmission via the application by which he has also created the digital emergency card. This can take place, for example, when the user, being a resident of the building, is present in the building at the time of the query.

Thus, on the one hand it can be ensured that information about the building in the form of the digital emergency card is only sent when the user wants that and approves it. This can also take place when there is an emergency, and the user is asked in the form of a current query by the central emergency service or emergency team to approve the stored digital emergency card. The emergency services can then access it.

According to a further embodiment, the method can be characterized in that a query to the user earlier in time can take place. The earlier query can be made by the central emergency service or even by the user's application. Transmission can then take place, for example, only if the user approves the transmission in reaction to the earlier query. The earlier query and the approval can be at a separate time from the transmission in reaction thereto. For example, the earlier query can take place shortly after the creation of the digital emergency card, for example when there is not yet an emergency. In that case the user can specify that the digital emergency card is approved in the event of an emergency for all emergency services. Later, if an emergency does occur, in reaction to this earlier query the digital emergency card can be sent since the digital emergency card has been approved in advance by virtue of the earlier query.

In that way an emergency activation can be implemented. Even if, for example, the user is not at home, the emergency services can call for the data from the server of the house. Thanks to the earlier query to the user and the prior approval by the user, the read emergency card can be sent without the user actually having to approve the transmission at the time of the emergency in reaction to a current query. However, transmission can only take place if, for example, the user approves it in response to the earlier query. If the user omits the prior approval, then for example no transmission takes place until approval in reaction to a current query. This ensures a high level of data security.

According to a further embodiment, the method can be characterized in that a set of authorized receivers can be specified. Specification can be done by the user, for example before an emergency or at the time of an emergency. The receiver can be an emergency service or an emergency vehicle. Before the user's specification, for example, the central emergency service can send the user identifiers of receivers. These identifiers can clearly describe and identify the receivers. The user can then, specifically with reference to the identifiers, define particular receivers that should be defined as authorized receivers. For example, the set can be specified by using the application. Furthermore, transmission to the set so defined can take place, for example, only to the defined set. A read emergency card cannot be sent to a receiver not included among the authorized receivers.

Thus, the user can specify to whom information on an emergency card that has been read is sent. For example, if the user is asked in the form of a current query to transmit in reaction to the current query only to the user, who are included among the authorized receivers. The set of authorized receivers can, for example, be specified by the user at the time of the emergency. Alternatively, or in addition, a user can specify the set of authorized receivers in advance, for example at the time when the digital emergency card is created. Thus, he can specify particular receivers who are included among the set of authorized receivers. In that case for example, particular emergency vehicles of fire stations in the neighborhood can be specified as authorized receivers. If, for example, the user is not in the building at the time of the emergency, transmission can take place only to that set of authorized receivers. This can be combined with the earlier query so that the user is asked in advance whether transmission is to take place and at the same time he specifies to whom, in an emergency, transmission should take place. In that way the user retains control over information on the emergency card and at the same time, in an emergency, the information on the emergency card is transmitted to the set of authorized receivers.

In a further embodiment, the method can be characterized in that a perimeter around the building can be specified. The user can specify the perimeter. Alternatively, or in addition, the central emergency service can specify the perimeter. The user can specify the perimeter by means of the application, for example, before or at the time of the emergency. Transmission can take place to receivers within the specified perimeter, for example, to many or all the receivers within the specified perimeter. Transmission can take place only to those receivers who are within the specified perimeter. In that case it can be determined by GPS whether a receiver is or is not within the specified perimeter. For example, the central emergency service can determine which receivers are within the specified perimeter.

In this way it can be ensured that the emergency card is transmitted only to relevant receivers, namely for example, emergency services within the perimeter around the building. This can increase data security further. The transmission to relevant receivers can be combined with the current query and alternatively or in addition with the earlier query. Alternatively, or in addition, transmission to a receiver within the perimeter can be combined with transmission to authorized receivers.

According to a further embodiment the method can be characterized in that transmission can take place in reaction to an alarm. The alarm can for example be triggered by the user of the building or by some other person. The alarm itself can in that case be independent of the approval or the queries, as described earlier.

In that way the transmission can be restricted only to situations in which there is an alarm. The alarm can for example be triggered only in emergency situations and thus sparing data transmission, which also increases data protection, can be implemented. Sending information on the emergency card without reason, i.e., when there is no emergency, can therefore be prevented.

In a further embodiment, the method can be characterized in that transmission to a central emergency service can take place. Alternatively, or in addition, transmission can take place to a receiver such as an emergency team or emergency vehicle. Furthermore, transmission from the central emergency service to those receivers can take place.

In that way information on the digital emergency card can be sent to the central emergency station and from there to the operations management and emergency forces on the way to the building or on the spot in the building.

A second aspect of the invention relates to a system consisting of a storage medium, a terminal, and a transmission and reception device. The storage medium can be a server in the building. The terminal can be a mobile terminal of the user's, such as a Smartphone with an application. The user can create the emergency card and update it by means of the application. The transmission and reception device can be designed to send data about the emergency card that has been read. The system is designed to carry out steps of the method in accordance with an embodiment of the first aspect of the present invention. Furthermore, the system can include the central emergency service, one or more receivers and a validation point.

With such a system and such a storage medium the costs can be reduced since no rental fees for a server outside the building are involved. Moreover, data security can be increased, since access to information relating to the digital emergency card is only possible by way of the server and the storage medium.

### BRIEF DESCRIPTION OF THE FIGURES

FIG. 1: A schematic diagram showing the steps of a method for creating a digital emergency card.

FIG. 2: A schematic diagram showing the elements of a system for carrying out the method shown schematically in FIG. 1.

### DETAILED DESCRIPTION OF EMBODIMENTS

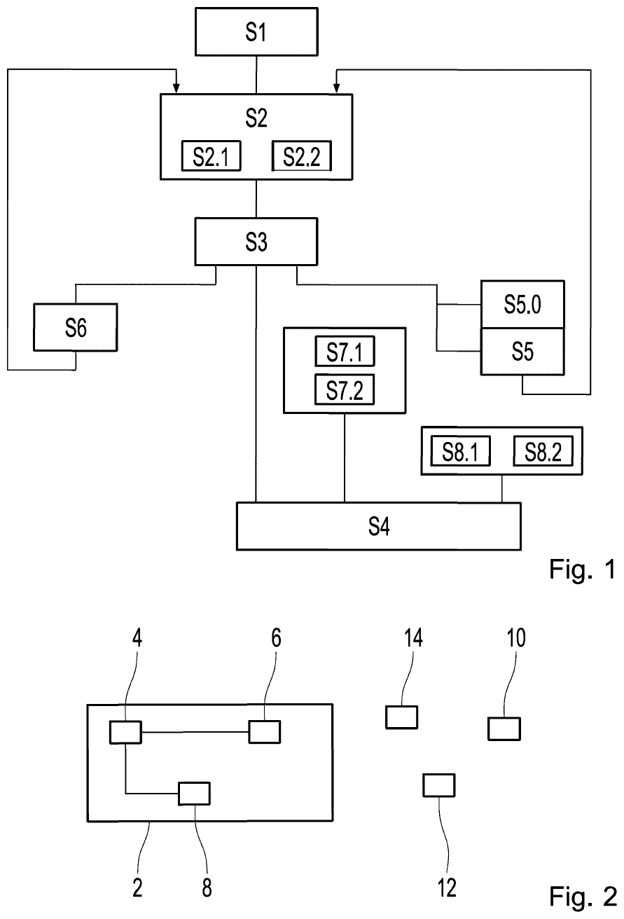

FIG. 1 shows schematically the steps of a method for creating a digital emergency card. FIG. 2 shows a system consisting of a storage medium 4, a terminal 6, and a transmission and reception device 8. In addition, the system shown in FIG. 2 includes a central emergency service 10, a receiver 12 which is an emergency team, and a validation point 14. The system is designed to carry out the steps of the method shown schematically in FIG. 1. The storage medium 4, the terminal 6, and the transmission and reception device 8 are part of a building 2. The system includes further receivers (not shown).

A user creates S1 a digital emergency card for the building 2. The user is a resident of the building 2. The creation S1 takes place by way of an application of the terminal 6, which is a Smartphone. In addition, the emergency card created is stored S2 in the storage medium 4 of the building 2. For that purpose, the terminal 6 is connected so as to communicate with the storage medium 4. The creation S1 and the storing S2 of the emergency card take place before any emergency and in a situation in which there is no emergency.

When an emergency occurs, the stored emergency card is read S3 from the storage medium 4. Furthermore, the emergency card, once read, is transmitted S4 by means of the transmission and reception device 8. The transmission takes place to the central emergency service 10, which is outside the building 2. The emergency card transmitted and read is passed on by the central emergency service 10 to the receiver 12.

When a situation of the building 2 changes, for example because a layout of the building has changed or a new hazard source has been added, the read emergency card is updated S5. The updating S5 is carried out by the user with the application by means of the terminal 6. In addition, the updated emergency card is stored S2.1 in the storage medium. The previously stored emergency card is overwritten. When a certain time since the last updating S5 has lapsed, a reminder S5.0 is sent to the user to update S5. The reminder is sent S5.0 by the application. This ensures that the stored emergency card is always updated.

Furthermore, after being read the emergency card is validated S6. Validation S6 takes place by way of the validation point 14 and earlier in time than an emergency. The validation point 14 in this case is an operative force of the firefighting system. This validates the fact that the information in the emergency card created and stored corresponds to the actual condition of the building 2. The validated emergency card is then stored S2.2 in the storage medium 4. During transmission it is the validated emergency card which is sent. Thus, the emergency forces can be sure that the emergency card they have received also actually corresponds to the condition of the building, since it is validated. Validation S6 is carried out not by the user himself, in this case the resident of the building 2, but by an external user such as the emergency force described earlier.

The validated emergency card is assigned a confidence level. Thus, when it is validated the emergency card is given a particular confidence level. If the external user, in this case the emergency force, validates the emergency card, the emergency card is given a higher confidence level than if only the user, as a resident of the building 2, validates the emergency card as happens in another embodiment. The confidence level decreases over time. This takes place in a linear manner. The change is sent to the user for the updating operation S5 when the confidence level has fallen below a particular value. The particular value is previously defined by the user or specified by the external user. After updating S5, the confidence level increases. With this updating S5 a user specifies a changed condition of the building 2 by inputting it into the application of the terminal 6. In an embodiment not described further, instead of the updating S5, a validation is carried out by the user if the condition of the building 2 has not changed. In that way the user ensures that the information already stored in the emergency card corresponds to the current condition of the building.

Transmission S4 takes place subject to the user's approval. No transmission takes place if a user has not given approval. In an emergency one of the following scenarios occurs. A first situation concerns the case when the user is inside the building 2. A current query S7.1 to the user is sent by the central emergency service 10. The current query 7.1 is sent after an alarm. Transmission S4 only takes place if the user approves the transmission S4 in reaction to the current query S7.1. Thus, at the time of the emergency the user approves the transmission S4 in reaction to the current query S7.1. Then, the information on the emergency card that has been read is sent to the central emergency service 10 and on to the receiver 12.

A second situation describes the case when at the time of the emergency the user is not in the building 2. In that case an earlier query S7.2 to the user takes place. This earlier query S7.2 is sent to the user by the application of the terminal 6. Transmission S4 then takes place when the user approves the transmission S4 in reaction to the earlier query S7.2. Thus, shortly before creating S1 the emergency card in reaction to the earlier query S7.2 the user approves the later transmission S4. Subsequently, at the time of an alarm and an emergency, transmission S4 takes place in reaction to the earlier query S7.2 and in reaction to the approval. In that way a data approval can be stored already before an emergency and the earlier query S7.2 can take place before the alarm and the emergency.

In a third situation, the user is again not in the building 2 at the time of the emergency. A set of authorized receivers 12 is specified S8.1. This specification S8.1 is done by the user by means of the application. The specification S8.1 takes place before an emergency. For that purpose, the central emergency station 10 sends the user knowledge of the receivers 12 before the emergency. The user then specifies the set of authorized receivers 12. Later, after an alarm and an emergency, transmission S4 takes place to the set so specified. Thus, only receivers 12 who have been specified in advance as authorized by the user of the building 2 receive the emergency card via the transmission S4.

Furthermore, a perimeter is defined S8.2, such that the perimeter is a boundary around the building 2. The user defines S8.2 the perimeter by means of the application. Thus, the perimeter includes certain locations around the building 2. Transmission S4 takes place to receivers 12 within the defined perimeter. In an embodiment transmission S4 takes place to previously specified authorized receivers 12 who are within the perimeter. Thus, there is no transmission S4 to authorized receivers 12 who are not within the perimeter, or to receivers 12 who, although they are authorized, are not authorized.

Transmission S4 always takes place in reaction to an alarm which is activated in reaction to an emergency. The alarm is activated by the central emergency station 10.

### INDEXES

2 Building
4 Storage medium
6 Terminal
8 Transmission and reception device
10 Central emergency service
12 Receiver
14 Validation point
S1 Creation of a digital emergency card
S2 Storing of the emergency card created
S2.1 Storing of an updated emergency card
S2.2 Storing of a validated emergency card
S3 Reading of the stored emergency card
S4 Transmission of the emergency card that has been read
S5.0 Sending of a reminder
S5 Updating of the emergency card that has been read
S6 Validation of the emergency card
S7.1 Current query
S7.2 Earlier query
S8.1 Specification of a set of authorized receivers
S8.2 Specification of a perimeter around the building

1-14. (canceled)

15. A method for providing a digital emergency card, comprising:
creating (S1) a digital emergency card for a building by a user of the digital emergency card;
storing (S2) the emergency card in a storage medium (4) of the building (2);
reading (S3) the stored emergency card from the storage medium (4); and
transmitting (S4), after reading, the stored emergency card.

16. Method according to claim 15, comprising:
updating (S5) the read emergency card, resulting in an updated emergency card; and
storing (S2.1) the updated emergency card in the storage medium (S4).

17. The method according to claim 16, comprising:
sending to the user a reminder to update (S5) the digital emergency card after a predefined time limit has lapsed.

18. the method according to claim 15, comprising:
validating (S6), after reading, the digital emergency card; and
storing (S2.2) the validated emergency card in the storage medium (4);
wherein transmitting the stored emergency card includes transmitting the validated emergency card.

19. The method according to claim 18, wherein validating (S6) the digital emergency card is carried out by an external user.

20. The method according to either of claim 18, comprising:
assigning a confidence level to the validated emergency card, wherein the confidence level decreases over time;
sending (S5.0) to the user a reminder to update (S5) the digital emergency card when the confidence level has fallen below a predefined value; and
increasing the confidence level after the updating (S5).

21. the method according to claim 15, wherein transmitting the stored emergency card (S4) takes place subject to receiving approval from the user.

22. The method according to claim 21, comprising:
sending a current query (S7.1) to the user;
receiving from the user an approval in response to the current query; and
wherein transmitting (S4) the stored emergency card takes place after receiving the approval.

23. the method at least according to claim 22, wherein the current query is a subsequent query and the method further comprising:
sending a previous query (S7.2) to the user; and
receiving from the user a previous approval in response to the previous query; and
wherein transmitting (S4) the stored emergency card takes place after receiving the previous approval.

24. The method according to claim 22, comprising:
specifying (S8.1) a set of authorized receivers (12), wherein transmitting the stored emergency card (S4) is carried out to the set of authorized receivers.

25. The method according to claim 24, comprising:
specifying (S8.2) a perimeter around the building (2), wherein transmitting (S4) the stored emergency card is carried out to receivers (12) within the specified perimeter.

26. The method according to claim 15, wherein transmitting (S4) the stored emergency card is carried out in response to an alarm.

27. The method according to claim 15, wherein transmitting (S4) the emergency card is carried out to a central emergency service (10).

28. A system consisting of a storage medium (4), a terminal (6), and a transmission and receptions device (8), the system being configured to carry out steps of the method according to claim 15.
